(19) United States
(12) Patent Application Publication
(10) Pub. No.: US 2010/0011283 A1
(43) Pub. Date: Jan. 14, 2010

(54) MINIMIZING THE COPYING OF AN EXTENSIBLE MARKUP LANGUAGE (XML) TREE WHEN REFERENCING TREE NODES DURING EXTENSIBLE STYLESHEET LANGUAGE TRANSFORMATIONS (XSLT) PROCESSING

(75) Inventor: John C. R. WRAY, Chelmsford, MA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/170,710

(22) Filed: Jul. 10, 2008

(51) Int. Cl. G06F 17/00

(52) U.S. Cl. 715/234

(57) ABSTRACT

The invention includes a label tree action and a generate reference action function. The label tree action can execute a first time a copy of an XML tree is made (or when an XML tree is analyzed and determined not to contain id_attributes). The add id_attribute can add an id_attribute for each element of the XML tree that does not already have an associated id_attribute. This attribute can be set to a value returned by an XSLT generate-id( ) function. The generate reference action can deliver a string that will be used to refer to a given element. When an id_attribute for the given element is present within the XML tree, the generate reference action can return a value of the id_attribute. When no id_attribute is present for the given element, the generate reference action can return a value of the XSLT generate-id( ) function for the element.

### BACKGROUND OF THE INVENTION

The present invention relates to the field of extensible markup language (XML) document processing, and, more particularly, to minimizing the copying of an XML tree when referencing tree nodes during extensible stylesheet language transformations (XSLT) processing.

There are times when one extensible markup language (XML) document must refer to locations within another XML document. An example of this is when analyzing a document to produce a report of any policy or profile conformance violations. The produced report (which is an XML document) should include references to the places where the violation occurs, which is a location in another XML document. One XML standard for this type of reference is to annotate the target element in the referenced document with an “id” attribute, where the referencing document uses the “id” attribute when referencing the target element. This “labeling on demand” (i.e., adding an id annotation for a target element when needed) does not work well in a many functional XML manipulation contexts. For example, when Extensible Stylesheet Language Transformations (XSLT) are used to transform one XML data structure into another, making a change to any part of the XML tree (including adding an “id” attribute) can require the entire tree to be copied, which is computationally expensive.

FIG. 1 (Prior Art) is a functional diagram of a system 100 depicting the handling of XSLT actions by an XSLT processor that modify and/or reference a node of an XML tree. In system 100, the transformation rules contained within the XSLT documents 110 are applied to a source XML tree of the input XML document 105 by an XSLT processor 115 to produce an output XML document 135. The XML processor 115 applies a set of rule actions 120, which iteratively modify/reference an XML tree 130. Each rule application/modification cycle requires a copy tree action 125. Significant processing time is required to generate the output XML document 135, largely due to the time/resources consumed by the copy tree actions 125.

### BRIEF DESCRIPTION OF THE SEVERAL VIEWS OF THE DRAWINGS

There are shown in the drawings, embodiments which are presently preferred, it being understood, however, that the invention is not limited to the precise arrangements and instrumentalities shown.

FIG. 1 (Prior Art) is a functional diagram of a system depicting the handling of XSLT actions by an XSLT processor that modify and/or reference a node of an XML tree.

FIG. 2 is a functional diagram of a system depicting the minimization of tree copying actions when an optimized XSLT processor processes tree node references for an XML tree in accordance with embodiments of the inventive arrangements disclosed herein.

FIG. 3 is a flow chart of a method detailing the minimization of copying an extensible markup language (XML) tree when referencing tree nodes during extensible stylesheet language transformations (XSLT) processing by an optimized XSLT processor in accordance with an embodiment of the inventive arrangements disclosed herein.

### DETAILED DESCRIPTION OF THE INVENTION

The present invention discloses a solution that minimizes copying and increases performance of Extensible Stylesheet Language Transformations (XSLT) operations via a specialized use of the generate-id( ) function. The generate-id( ) function is a function of the XSLT language that returns a unique node-id string for each element that can be used to name the element. The XSLT specification does not define the format of the string returned by generate-id( ), it merely states that every element within a document will have a distinct node-id value returned by generate-id( ) and that repeated inquiries on a given element will return the same value. There is no assumption that calling generate-id( ) on corresponding elements in different copies of a document will return the same or related node-ids. Conventional implementations of generate-id( ) function generate different node-ids for different copies of a document.

The present invention uses the node-id values returned by the generate-id functions as a value for the “id” attribute of an XML document. That is, every time a reference is needed to the XML document, the target element can be referenced by the appropriate id attribute, which is the value of the generate-id( ) function for that element. A first time an XML tree is copied, explicit “id” attributes are added to each target element, each having the value given by applying the generate-id( ) function to the original element. These “id” attributes, which have the same values as the original generate-id( ) returns can be utilized during XML tree transformations. This technique permits references to be made to nodes in the XML tree, regardless of whether a copy containing the “id” attributes has yet been made. The first time the tree needs to be copied (either because it has to be modified, or because it is being serialized), the “id” attributes are inserted during the copy process. On subsequent copy operations, they are simply carried forward from one copy to another. Therefore, when the tree is finally serialized, the “id” attributes will be present, and will contain the values derived via the generate-id( ) function on the elements of the original source tree, ensuring that references made using these attribute values will be valid references into the corresponding elements in the serialized tree.

The present invention has an advantage that no extra copy of the XML tree is needed in many cases, which conserves computing resources and minimizes document “bloat”. For example, in a case of conformance or policy analysis of a conformant document, where there will be no need to create references into the XML tree, a labeled form of the XML document is not needed and will never be created. When the XML tree needs to be copied for some reason (e.g., the tree needs to be modified or serialized, for example), then “id” attributes can be inserted at this time. On subsequent copy operations, the “id” attributes will simply be copied into the target tree. In one embodiment, assuming appropriate support from the compiler and/or run-time system, the insertion of “id” attributes can be automatically performed as part of the serialization process, thereby completely avoiding the need to make an extra copy of the XML tree.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

FIG. 2 is a functional diagram of a system 200 depicting the minimization of tree copying actions 225 when an optimized XSLT processor 215 processes tree node references 224 for an XML tree 205 in accordance with embodiments of the inventive arrangements disclosed herein. Copy actions 225 are minimized using a label tree action 230 and the generate reference action 235. The label tree action 230 can execute a first time a copy of an XML tree is made (or when an XML tree is analyzed and determined not to contain id attributes). Action 235 can add an id_attribute for each element of the XML tree that does not already have an associated id_attribute. This attribute can be set to a value returned by an XSLT generate-id( ) function. An id_attribute can be a structural element of the XML tree for data value unique to an element that is able to be referenced to identify the element.

The generate reference action 235 can deliver a string that will be used to refer to a given element. When an id_attribute for the given element is present within the XML tree 245, the generate reference action 235 can return a value of the id_attribute. When no id_attribute is present for the given element, the generate reference action 235 can return a value of the XSLT generate-id( ) function for the element.

Although system 200 describes the inventive arrangements in terms of the XSLT language, the invention is not limited in this regard. Any transformation language can be used instead of the XSLT language, where the language preferably has a function equivalent to the XSLT generate-id( ) function. Additionally, system 200 illustrates a set of functionality for minimizing tree copying actions 225 for tree node references 224. Although discrete components are shown for illustrative purposes, boundaries imposed by these components are arbitrary and any set of components can be utilized within system 200 so long as a cumulative effect is similar to the components shown in FIG. 2.

As shown in system 200, the optimized XSLT processor 215 can apply one or more XSLT documents 210 to a received source XML tree 205 in order to produce an output XML tree 250. The source XML tree 205 can be a tree representation of an XML document created by a parser (not shown). The XSLT documents 210 can contain a variety of rules written in a standardized format that can be executed by the optimized XSLT processor 215 upon the XML tree 205.

The optimized XSLT processor 215 can represent a software component designed to execute the rules contained within XSLT documents 210 upon an XML tree 205. The optimized XSLT processor 215 can be further configured to execute the reference actions 224 of XSLT documents 210 in such a manner that the quantity of tree copying actions 225 can be minimized.

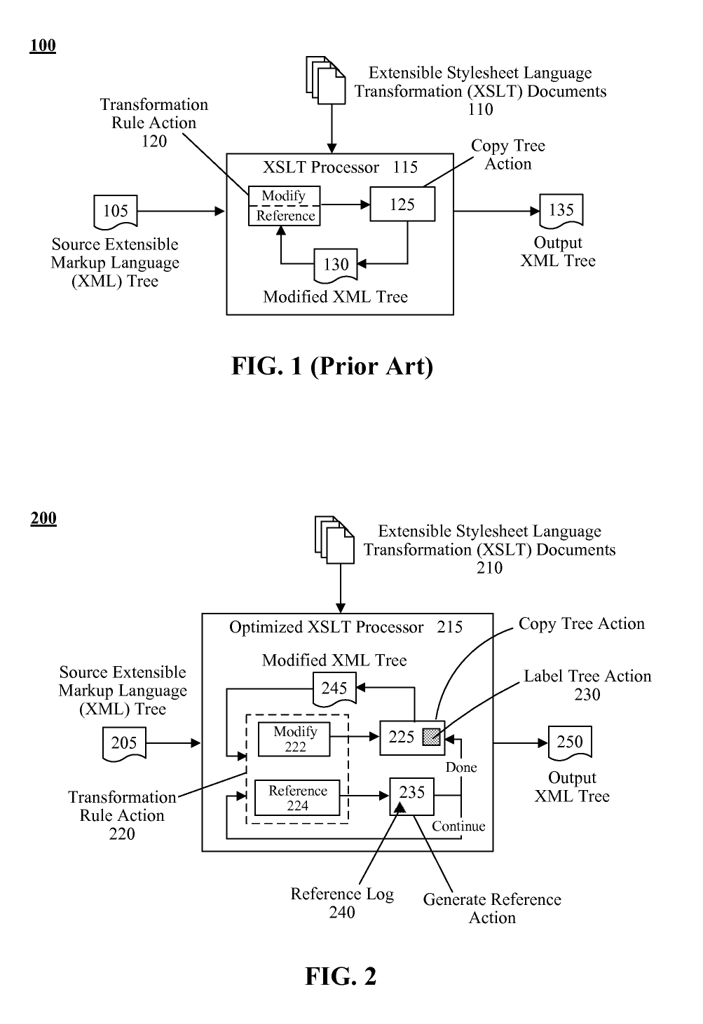

Unlike conventional XSLT processors, such as that shown in FIG. 1, the optimized XSLT processor 215 can handle reference actions 224 for the XML tree 205 without executing a tree copying action 225 for each reference action 224. When handling a reference action 224, the optimized XSLT processor 215 can execute a generate reference action 235. The generate reference action 235 can create a unique identifier for the tree node of the XML tree 205 that is being referenced. It should be noted that the generate reference action 235 need only be executed when the tree node does not already contain an ID attribute to reference.

The unique identifier created by the generate reference action 235 can be used as a value for an ID attribute to be added to the XML tree 205 when generating the modified XML tree 245 or output XML tree 250. The generate reference action 235 can utilize the generate-id( ) function defined in the XSLT specification to generate the unique identifier. Use of the generate-id( ) function can ensure that a unique string is returned for each node in the XML tree 205 and that repeated executions on the same node returns the same unique string. That is, multiple executions of the generate-id( ) function on the same tree node in the same, unmodified XML tree 205 will always return the same unique string.

Therefore, each source XML tree 205 and modified XML tree 245 can be thought of as having a unique identifier for each tree node even if the tree nodes do not contain ID attributes. Such an approach can allow for multiple references to be made to tree nodes without requiring multiple tree copying actions 225.

In one embodiment, an optional reference log 240 can be used to suppress the addition of “id” attributes for nodes that are not referenced. In this embodiment, the generate reference action 235 can record data about the generated reference in a reference log 240 so that all the generated references can be added to the modified XML tree 245 at once or when a copy tree action 225 is required to be executed. For example, the generate reference action 235 can generate the unique identifier and then record the tree node to which the ID attribute is to be added and the generated value for the ID attribute in the reference log 240. Use of a reference log 240 can result in a more readable output tree 250 relative to embodiments of system 200 that do not implement the reference log 240. That is, embodiments of system 200 that do not implement the reference log 240 can generate a fully labeled tree 250, as opposed to a minimally labeled tree in which only the referenced elements have “id” attributes.

Upon completion of the generate reference action 235, the optimized XSLT processor 215 can continue executing transformation rule actions 220 or complete the processing of the output XML tree 250. Continued processing can include the execution of transformation rule actions 220 that trigger a copy tree action 225, such as a modify tree action 222.

The copy tree action 225 executed by the optimized XSLT processor 215 can be modified to contain a label tree action 230 that can handle the insertion of ID attributes to those tree nodes recorded in the reference log 240. The label tree action 230 can be configured to check the reference log 240 for entries before initiating the copy tree action 225.

The label tree action 230 can be configured to coordinate the ID attribute data from the reference log 240 into the specified tree nodes during the execution of the copy tree action 225. For example, the label tree action 230 can work in concert with the copy tree action 225 by inserting ID attributes with the generated values into the specified tree nodes as those tree nodes are copied from the source XML tree 205 into the modified XML tree 245.

In one embodiment, the reference log 240 can be emptied to allow a final label tree action 230 to be avoided. That is, if the label tree action 230 has already run and no additional references have been generated and logged subsequently, then the tree already has all the labels that it needs. This optimization requires that the log entries placed in the reference log 240 to be only generated when references are made to elements that do not already have an “id” attribute. That is, the log 240 can always contain a list of the elements (identified by their node id's) that will have to be given “id” attributes when these elements are copied.

When processing of the source XML tree 205 is complete, the optimized XSLT processor 215 can check the reference log 240 for entries. If entries exist in the reference log 240 that have not been incorporated into a modified XML tree 245, then the label tree action 230 can be invoked. It should be noted that invoking the label tree action 230 also invokes a copy tree action 225, since adding attributes to tree nodes requires a copy of the XML tree 205 to be made.

The copy tree action 225 can produce a modified XML tree 245 from the source XML tree 205. The modified XML tree 245 can then be used for additional processing. When processing is complete, the last modified XML tree 245 produced can be used as the output XML tree 250 of the optimized XSLT processor 215 to the serializer (not shown).

The flow of action execution within system 200 can be further clarified through an example processing of an XML tree. For the purposes of illustration, the XML tree 205 being processed by the optimized XSLT processor 215 can be a typical network message upon which a variety of analyses can be performed. The analyses can represent various actions, such as checking the message for conformance to business rules or security protocols, which can be represented by various XSLT documents 210.

System 200 requires only a single copy to be made in order to obtain a minimally labeled tree 250 (assuming a reference log 240 implementation). Further, the use of the generate-id( ) function allows for the single copy to be delayed unit the tree 205 needs to be copied. In many cases, the tree 205 copying is unnecessary, which means that in many cases system 200 incurs copying overhead whatsoever.

In one example scenario, each processor can execute eleven actions in the order of five references, a modification, and five more references. The optimized XSLT processor 215 would execute two copy tree actions 225. The first of these is one that is necessary anyways as part of the modify action. The adding of the “id” attributes to those elements that are called out in the log 240 as being the target of references can be “piggy-backed” to this first copy action. The only additional copy action needed is a final one. This additional copy can be minimized in many situations assuming appropriate support from the compiler and/or run-time system exists. That is, the insertion of “id” attributes can be automatically performed as part of the serialization process, thereby completely avoiding the need to make an extra copy of the XML tree.

Further, in an embodiment where a minimally-labeled tree is not needed (i.e., a fully-labeled one will suffice and a reference log 240 need not be maintained) no additional copies are needed (even without run-time support) since the first copy operation would completely label the tree, allowing the subsequent references to be made without requiring new attributes to be added.

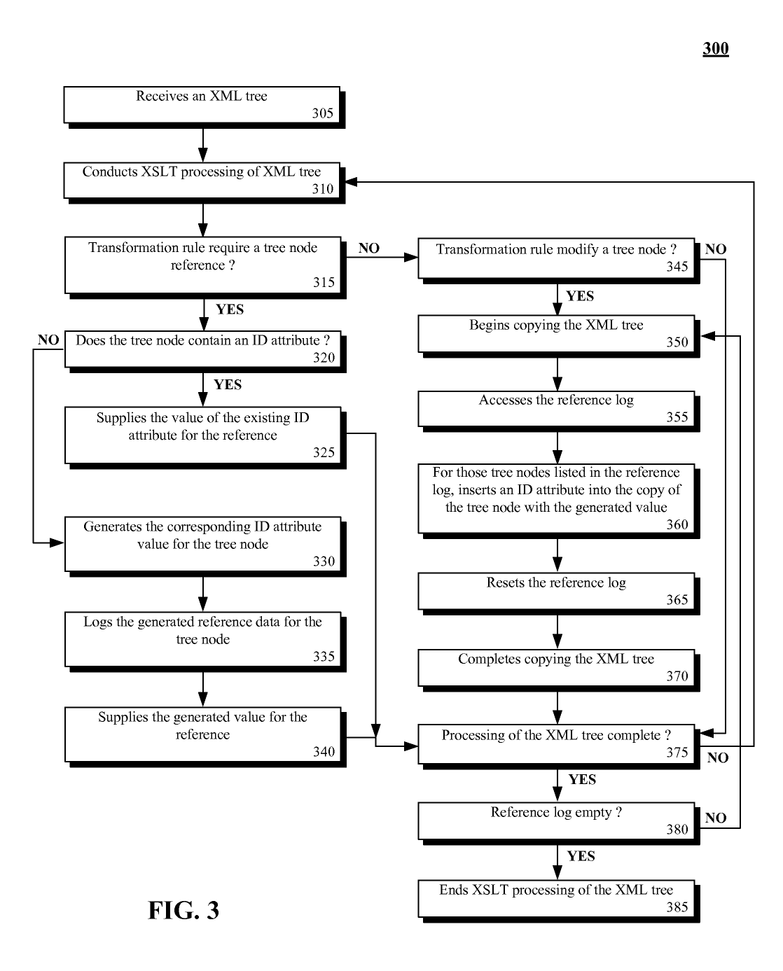

FIG. 3 is a flow chart of a method 300 detailing the minimization of copying an extensible markup language (XML) tree when referencing tree nodes during extensible stylesheet language transformations (XSLT) processing by an optimized XSLT processor in accordance with an embodiment of the inventive arrangements disclosed herein. Method 300 can be performed in the context of system 200 or any other system configured to minimize the copying of an XML tree when referencing tree nodes during XSLT processing.

Method 300 can begin with step 305 where an XML tree can be received by the optimized XSLT processor. XSLT processing of the XML tree can be conducted in step 310. In step 315, it can be determined if a transformation rule being executed requires a reference to a tree node.

When it is determined that the transformation rule requires a reference to a tree node, step 320 can execute where it can be determined if the tree node being referenced already contains an ID attribute. When the tree node contains an ID attribute, the value of the existing ID attribute can be supplied for the reference in step 325.

When the tree node does not contain an existing ID attribute, step 330 can execute where a value for the ID attribute can be generated for the tree node. Step 330 can utilize the generate-id( ) function already defined within the XSLT specification. In step 335, the generated reference data for the tree node can be logged. The generated value can be supplied for the reference in step 340.

When it is determined that the transformation rule does not require a reference to a tree node, step 345 can execute where it can be determined if the transformation rule modifies a tree node. When the transformation rule modifies a tree node, copying of the XML tree can begin in step 350. In step 355, the optimized XSLT processor can access the reference log.

For those tree nodes listed in the reference log, an ID attribute can be inserted into the copy of the tree node with the generated value in step 360. In step 365, the reference log can be reset. The reference log can be reset as a whole after all entries have been incorporated into the copy of the XML tree or on a per entry basis after the entry is incorporated. In step 370, the copying of the XML tree can be completed.

Step 375 can execute upon completion of step 325, 340, and/or 370. In step 375, it can be determined if the processing of the XML tree is complete. When it is determined that processing is not complete, flow can return to step 310 where the processing of the XML tree can be continued.

When processing of the XML tree is determined to be complete, step 380 can execute where it can be determined if the reference log is empty. When the reference log is determined to be empty, the XSLT processing of the XML tree can end in step 385. When the reference log is determined to contain data, flow can return to step 350 where the XML tree can be copied and ID attributes incorporated for the references.

The diagrams in FIGS. 2-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for minimizing copy actions when transforming an extensible markup language (XML) document comprising:
identifying a source extensible markup language (XML) document;
executing a transformation action against the source XML document, wherein the transformation action conforms to a standard language for the transformation of XML documents;
when the source XML document has not been copied, referencing at least one target element of the source XML document using a node-id function of the standard language; and
when the source XML document has been copied at least one, referencing target elements of the source XML document using a value of an id_attribute associated with the target element.

2. The method of claim 1, further comprising:
determining that the source XML document is to be copied when executing the transformation action;
detecting whether each element of the source XML document is associated with an id_attribute;
for each element of the source XML document not associated with the id_attribute, adding an id_attribute for that element and setting a value of the added id_attribute to a return value of the node-id function for that element; and
generating a copy of the source XML document having the added id_attributes.

3. The method of claim 2, wherein the transformation action is one of a plurality of transformation actions taken while generating a target XML document from the source XML document, wherein when executing the plurality of transformation actions only one copy of the source XML document is needed, wherein all references to target elements of the copied document are based upon the id_attribute value associated with the target element.

4. The method of claim 1, wherein the standard language for the transformation of XML documents is an Extensible Stylesheet Language Transformations (XSLT) based language, and wherein the node-id function is the XSLT generate-id( ) function.

5. The method of claim 1, wherein the transformation action is one used for determining conformance to a conformant document, wherein the transformation action is performed without copying the source XML document and is performed by using references to the target element generated by the node-id function.

6. The method of claim 1, further comprising:
detecting an action, which results in the source XML document being copied for a first time;
responsive to the detected action and for each element of the source XML document, adding an id_attribute to each element of the source XML that does not otherwise have an id_attribute to create a fully-labeled source XML document, where a value of each added id_attribute is a value returned by a node-id function for that element.

7. The method of claim 1, further comprising:
maintaining a log of references by adding a record each time the referencing of the source XML document using the node-id function occurs;
detecting an action, which results in the source XML document being copied;
responsive to the detected, adding an id_attribute to each element of the source XML that does not otherwise have an id_attribute and that is included in the log of references to create a minimally-labeled source XML document, where a value of each added id_attribute is a value returned by a node-id function for that element, and wherein elements of the source XML not included in the log do not have an id_attribute added to them during the adding step.

8. The method of claim 1, wherein said steps of claim 1 are performed by at least one machine in accordance with at least one computer program stored in a computer readable storage media, said computer programming having a plurality of code sections that are executable by the at least one machine.

9. A method for minimizing the copying of an extensible markup language (XML) tree when referencing tree nodes during extensible stylesheet language transformations (XSLT) processing comprising:
receiving an extensible markup language (XML) tree;
applying at least one transformation rule within at least one extensible stylesheet language transformation (XSLT) document to at least one tree node of the XML tree; and
when applying the at least one transformation rule, referencing the at least one tree node using a label function, wherein the label function is configured to deliver a string that will be used to refer to the at least one tree node, wherein the label function is configured to return a value of the id_attribute when an id_attribute for the given element is present within the XML tree, and wherein the label function is configured to return a value of the XSLT generate-id( ) function when no id_attribute is present for the at least one tree node.

10. The method of claim 9, when the at least one transformation rule is identified as a tree node reference rule, supplying a unique identifier for a reference to a target tree node of the tree node reference rule.

11. The method of claim 9, wherein the applying of the transformation rule does not result in a copy of the XML tree, wherein the label function references the at least one tree node based upon the return value of the XSLT generate-id( ) function.

12. The method of claim 11, wherein the at least one transformation rule is one used for determining conformance to a conformant document associated with the XML tree.

13. The method of claim 9, further comprising:
determining that the XML tree needs to be modified for a first time;
adding an id_attribute for each node of the XML tree; and
setting a value of the id_attribute for each node to a return value of the XSLT generate-id( ) function for that node; and
copying the XML tree comprising said id_attributes having the set values associated with each node of the copied XML tree.

14. The method of claim 19, further comprising:
determining that the XML tree needs to be modified, wherein said modification is not a first modification for the XML tree; and
modifying the XML tree based upon the reference value of the id_attribute.

15. The method of claim 9, wherein said steps of claim 9 are performed by at least one machine in accordance with at least one computer program stored in a computer readable storage media, said computer programming having a plurality of code sections that are executable by the at least one machine.

16. The method of claim 9, further comprising:
detecting an action, which results in the XML tree being copied for a first time; and
responsive to the detected action and for each element of the XML tree, adding an id_attribute to each element of the XML tree that does not otherwise have an id_attribute to create a fully-labeled XML tree, where a value of each added id_attribute is a value returned by a node-id function for that element.

17. The method of claim 9, further comprising:
maintaining a log of references by adding a record each time the label function returns a value of the XSLT generate-id( ) function because of a lack of the id_attribute for that element;
detecting an action, which results in the XML tree being copied;
responsive to the detected action, adding an id_attribute to each element of the XML tree that does not otherwise have an id_attribute and that is included in the log of references to create a minimally-labeled XML tree, where a value of each added id_attribute is a value returned by the XSLT generate-id( ) function for that element, and wherein elements of the source XML not included in the log do not have an id_attribute added to them during the adding step.

18. A system for referencing extensible markup language (XML) document elements comprising:
a generate reference action configured to construct references into an XML tree, wherein the generate reference action is configured to deliver a string that will be used to refer to a given element, wherein the label function is configured to return a value of the id_attribute when an id_attribute for the given element is present within the XML tree, and wherein the generate reference action is configured to return a value of a transformation_language_function for a node identifier as applied to the given element when no id_attributes is present for the given elements of the XML tree; and
an label tree action configured to be executed a first time a copy of the XML tree is made, wherein the add label tree action is configured to add an id_attribute for each element of the XML tree that does not already have an associated id_attribute, and wherein the label tree action is configured to initiate each added id_attribute with a return value of the transformation_language_function for a node identifier for that element.

19. The system of claim 18, wherein the transformation_language_function is an XSLT generate-id( ) function.
